(19) United States
(12) Patent Application Publication
(10) Pub. No.: US 2013/0223850 A1
(43) Pub. Date: Aug. 29, 2013

(54) MODULATION METHOD AND APPARATUS FOR AMPLITUDE- OR INTENSITY-MODULATED COMMUNICATION SYSTEMS

(71) Applicants: Johnny KAROUT, Vastra Frolunda (SE); Gerhard KRAMER, Munchen (DE); Frank R. KSCHISCHANG, Toronto (CA); Erik AGRELL, Partille (SE)

(72) Inventors: Johnny KAROUT, Vastra Frolunda (SE); Gerhard KRAMER, Munchen (DE); Frank R. KSCHISCHANG, Toronto (CA); Erik AGRELL, Partille (SE)

(21) Appl. No.: 13/491,655

(22) Filed: Jun. 8, 2012

Related U.S. Application Data
(60) Provisional application No. 61/602,104, filed on Feb. 23, 2012.

(51) Int. Cl. H04B 10/12; H04J 11/00; H04B 3/00; H04L 27/06; H04B 10/06

(52) U.S. Cl. 398/141; 375/340; 398/202; 375/257; 370/208; 370/209

(57) ABSTRACT

The present invention relates to a method for determining a signaling set, comprising: selecting a first basis function in the form of a symmetric pulse represented by an even function; selecting a second basis function orthogonal to the first basis function; wherein the second basis function is represented by an odd function having a shape determined by a variable parameter; and determining a signaling set comprising a plurality of data signals formed by linear combinations of the first and second basis functions based on a predetermined requirement of the signaling set. The invention also relates to a modulation and demodulation method using the signaling set, a device performing the modulation and demodulation method and to a system incorporating such a device.

### FIELD OF THE INVENTION

The invention relates to a method for determining a signaling set. The invention also relates to a modulation and demodulation method using the signaling set, a device performing the modulation and demodulation method and to a system incorporating such a device.

### TECHNICAL BACKGROUND

Multilevel modulation with information encoded onto the amplitude and phase of an electromagnetic carrier signal has attracted significant research interest in efforts to increase transmission rate and spectral efficiency.

However, the enabling technology for such modulation schemes is often not feasible for short-haul optical applications such as local area networks, data centers, and computer interconnects, where the overall cost and complexity has to be kept down. Intensity modulation and direct detection (IMDD) is commonly used in short-haul applications. In such a system, the information is modulated onto the intensity of the optical carrier using for example a laser diode and the receiver detects the instantaneous power of the received signal using a photodiode, thereby only using the intensity of the signal to transmit information.

In a system using an intensity modulated subcarrier signal, one challenge is to select a modulation format which offers a good trade-off between spectral efficiency and power efficiency as well as having low peak amplitudes in the generated electrical waveform, as high amplitude peaks may cause the electro-optic components (such as laser diodes and receivers) to operate in a nonlinear fashion.

### SUMMARY OF THE INVENTION

In view of the aforementioned, it is an object of the present invention to provide an improved modulation method, and in particular a modulation method suitable for subcarrier modulation in a system transmitting an electromagnetic carrier signal.

According to an aspect of the invention, the aforementioned object is achieved by a method for determining a signaling set, comprising: selecting a first basis function in the form of a symmetric pulse represented by an even function; selecting a second basis function orthogonal to the first basis function; wherein the second basis function is represented by an odd function having a shape determined by a variable parameter; and determining a signaling set comprising a plurality of data signals formed by linear combinations of the first and second basis functions based on a predetermined requirement of the signaling set.

The key advantages of the present invention are the tunable basis functions and the fact that signals can be portrayed in a two-dimensional Euclidean space. The former gives control of the spectral efficiency that can be achieved in an IM/DD communication system, and the latter simplifies the design of modulation formats as well as the transmitter and receiver structures.

According to one embodiment of the invention, there is provided a method for modulation, the method comprising: receiving a data stream; determining a signaling set according to the abovementioned method; and forming a modulated electrical signal from the data stream by using the plurality of data signals, and providing the modulated electrical signal representing the data stream.

In an embodiment of the invention, the method may further comprise modulating a light generating device using the modulated electrical signal. By using the modulated electrical signal according to the present invention to modulate a light generating device, such a light generating device can be incorporated as a transmitter in optical communication system based on intensity modulation and direct detection (IMDD). The present modulation method also fulfills the required normegativity constraint of an optical intensity-modulated channel. In an IMDD system, the average intensity of the light of the transmitter is controlled by controlling the electrical signal driving the light generating device. The optical signal is transmitted through a transparent medium such as an optical fiber or a free-space optical link, and at the receiving end a photodetector may advantageously function as a receiver. In an IMDD system, the present modulation method may be labeled subcarrier modulation, as the data stream is modulated first on an electrical subcarrier signal, which is then used to modulate the intensity of the optical carrier.

In an embodiment of the invention, the method may further comprise modulating a laser diode using the modulated electrical signal. Laser diodes of different kinds are commonly used in optical communication systems to provide the optical signal to be transmitted. Examples of laser diodes are pn-junction diodes, quantum well lasers, quantum cascade lasers, DFB lasers and vertical cavity surface emitting lasers (VCSELs). Other types of present and future suitable light generating devices, as well as all possible optical intensity modulators (such as Mach-Zehnder modulators, electro-absorption modulators or similar) are of course also possible and within the scope of the invention.

According to another aspect of the invention, there is provided a device for modulation, the device comprising: a data input for receiving a data stream; means for forming a modulated electrical signal from the data stream by using a plurality of data signals formed by linear combinations of a first and a second basis function based on a predetermined requirement of the data signals; wherein the first basis function provided in the form of a nonnegative symmetric pulse represented by an even function; the second basis function is orthogonal to the first basis function and is represented by an odd function having a shape determined by a variable parameter; and a signal output for providing the modulated electrical signal.

Effects and features of this aspect of the present invention are largely analogous to those described above in connection with the previously discussed aspect.

Means for forming a modulated signal may comprise signal processing software or hardware adapted and configured to modulate an electrical signal.

According to still another aspect of the invention, it is provided a system for transferring a data stream, the system comprising a device for modulating a data stream, the device comprising: a data input for receiving the data stream; means for forming a modulated electrical signal from the data stream by using a plurality of data signals formed by linear combinations of a first and a second basis function based on a predetermined requirement of the data signals; wherein the first basis function provided in the form of a nonnegative symmetric pulse represented by an even function; the second basis function is orthogonal to the first basis function and is represented by an odd function having a shape determined by a variable parameter; and a signal output for providing the modulated electrical signal; a transmitter for modulating the modulated electrical signal onto an electromagnetic carrier; a transmission line; a receiver for receiving the modulated electromagnetic carrier and detecting its intensity; and a demodulator adapted for demodulating the modulated electrical signal, thereby recreating the data stream. As mentioned above, also in this case the effects and features are largely analogous to those described above in connection with the previously mentioned aspects.

In one embodiment of the invention, the transmission line may advantageously be an optical transmission line. An optical transmission line may be an optical fiber but it may also be other types of transmission lines such as optical wave guides suitable for use in short distance chip-to-chip or intra-chip communication systems. However, the transmission line may equally well be any electromagnetic communication link such as wired, radio, microwave, or free-space optical transmission.

According to one embodiment of the present invention, the transmitter may advantageously be a light generating device. However, the transmitter may equally well be any transmitter able to produce an amplitude modulated electromagnetic signal. In particular the light generating device may advantageously be a laser diode. Other types of light generating sources suitable for use in a communication system may also be used, for example other types of lasers or light emitting diodes.

According to an embodiment of the invention, the receiver can advantageously be a photodetector, for example a photodiode. The photodetector receives the transmitted light and translates the optical signal to an electrical signal. In a photodetector, the amplitude of the generated electrical signal is a function of the intensity of the received light.

Further features of, and advantages with, the present invention will become apparent when studying the appended claims and the following description. The skilled addressee realize that different features of the present invention may be combined to create embodiments other than those described in the following, without departing from the scope of the present invention.

### BRIEF DESCRIPTION OF THE DRAWINGS

These and other aspects of the present invention will now be described in more detail with reference to the appended drawings showing exemplary embodiments of the invention, wherein:

FIG. 1 is a schematic view of a communication system according to the present invention;

FIG. 2 is a flow-chart schematically illustrating the modulation method according to the present invention;

FIG. 3 is a schematic representation of a basis function used in a modulation method according to an embodiment of the present invention;

FIG. 4 is a schematic representation of a basis function used in a modulation method according to an embodiment of the present invention.

FIG. 5 is a table outlining time domain representations together with the waveforms of an exemplary modulation signal set;

FIG. 6 is an exemplary set of basis functions according to an embodiment of the invention; and

FIGS. 7a and 7b illustrate exemplary modulation formats according to an embodiment of the invention.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled addressee. Like reference characters refer to like elements throughout.

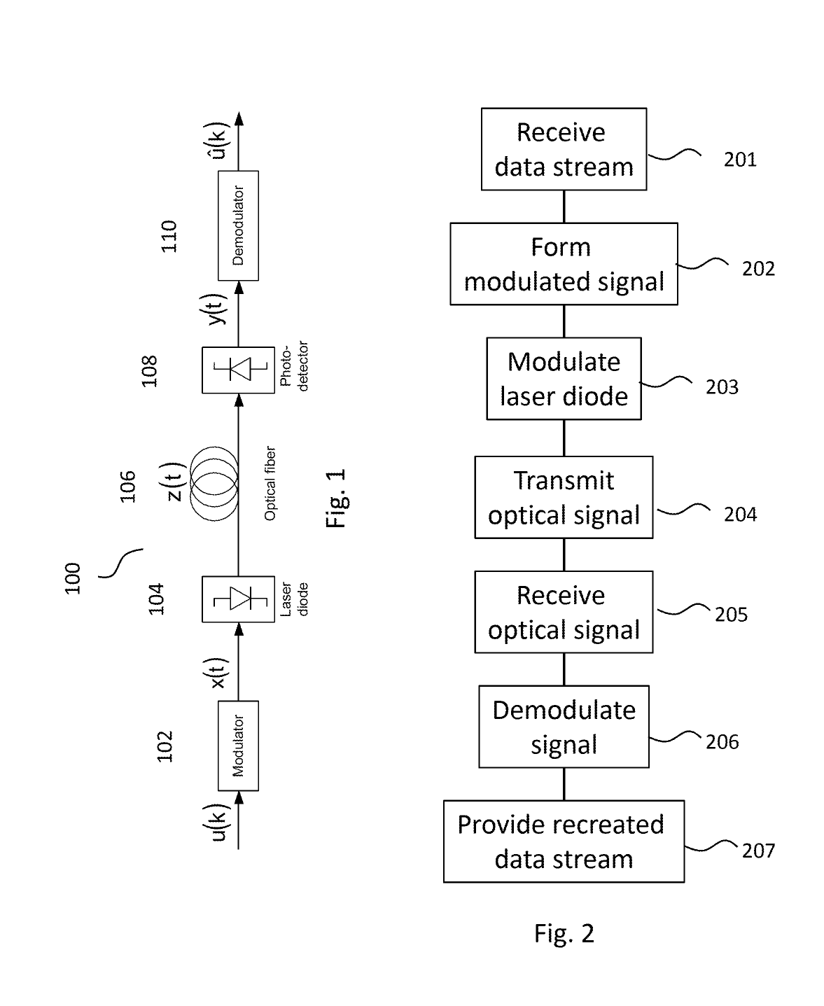

In the present detailed description, currently preferred embodiments of a method for modulation using a modulation signaling set according to the present invention are mainly discussed with reference to a system transferring a data stream. An exemplary embodiment of the present invention will now be described with reference to FIG. 1 schematically illustrating a system 100 transferring a data stream together with the flow-chart shown in FIG. 2.

The system 100 shown in FIG. 1 comprises a modulator 102 for receiving and modulating a data stream, a laser diode 104 for converting the electrical signal to an optical signal, an optical fiber 106 for transferring the optical signal, a photo detector 108 for converting the optical signal to an electrical signal and demodulator 110 for receiving and demodulating the electrical signal, thereby recreating the data signal.

With reference to the flow chart shown in FIG. 2, during operation of the system 100, a digital data stream is received at the input of the modulator in a first step 201. In the following step 202, the data stream is read by the modulator. The modulator then maps the symbol u(k)∈(0, 1, . . . , M−1) at instant k to an electrical waveform belonging to the modulation signal set S={ω₀(t), ω₁(t), . . . , ω_{M-1}(t)}. In the present context, a symbol represents one or more data bits, and each symbol is represented by a unique modulation signal.

In the next step, 203, the resulting positive electrical waveform x(t), which is provided at the output at the modulator, directly modulates a laser diode connected to the modulator.

Next, 204, the laser diode is connected to an optical fiber, transmitting the modulated optical signal z(t). Thereafter, in step, 205, the transmitted optical signal is received by a photodetector, converting the optical signal to an electrical signal y(t). The photo detector is in turn connected to a demodulator. The following step 206 comprises demodulating the received signal, recreating the original data stream. Finally, in the final step, 207, the recreated data stream û(k) is provided at an output of the demodulator.

The modulator 102 may be implemented using a type of generalized control unit. The control unit may in turn include a microprocessor, a microcontroller, a programmable digital signal processor or another programmable device. The control unit may also, or instead, include an application specific integrated circuit (ASIC), a programmable gate array logic, a programmable logic device, or a digital signal processor. Where the control unit includes a programmable device such as the microprocessor or microcontroller mentioned above, the processor may further include computer executable code that controls operation of the programmable device.

The signals in a modulation signaling set S for an amplitude- or intensity-modulated communication system can be generated according to the following description.

Each signal belonging to the signaling set S of size M can be represented as

$${w}_{i} ( t ) = G ( {w}_{i , 1} \sqrt{\frac{1}{T}} + {w}_{i , 2} {H}^{α} ( t ) ) p ( t )$$

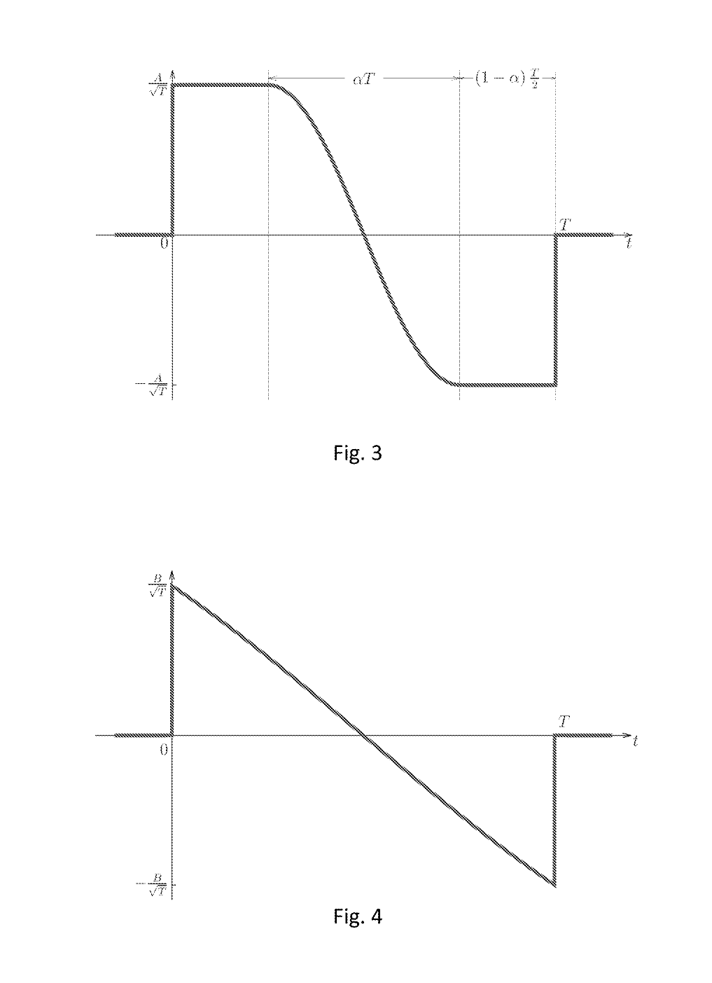

for i=0, . . . , M−1, where T is the symbol time, G is a scaling factor that allows the transmitted power to be adjusted, p(t) is a time-limited pulse of duration T, α is a variable parameter, and for

$$0 < α \leq 1 , \\ {H}^{α} ( t ) = \{ \begin{matrix}\frac{A}{\sqrt{T}} , & 0 \leq t < ( 1 - α ) \frac{T}{2} , \\ \frac{- A}{\sqrt{T}} sin ( 2 π {f}_{s} ( t - T / 2 ) ) , & ( 1 - α ) \frac{T}{2} \leq t < ( 1 + α ) \frac{T}{2} , \\ \frac{- A}{\sqrt{T}} , & ( 1 + α ) \frac{T}{2} \leq t < T ,\end{matrix} \\ α > 1 , \\ \begin{matrix}{H}^{α} ( t ) = \frac{- A}{\sqrt{T}} sin ( 2 π {f}_{s} ( t - T / 2 ) ) , & 0 \leq t < T ,\end{matrix}$$

where fₛ=1/(2αT) is the subcarrier frequency, and A is a constant depending on the energy of the pulse. This pulse is depicted in FIGS. 3 and 4 for 0<α≦1 and α>1, respectively, where

$$B = A sin ( \frac{π}{2 α} ) .$$

The pair (ω_{i,1}, ω_{i,2}) for signal i should be chosen such that ωᵢ(t)≧0 for all 0≦t<T, which guarantees the normegativity of the subcarrier signal x(t).

At the receiver, the signal x(t), or a noisy version of it, is recovered by detecting the amplitude or intensity of the signal that propagated the transmission medium. This will be followed by a demodulator which outputs the data stream that x(t) carries. The optimum demodulator is a correlator or matched filter receiver, which minimizes the symbol error rate at a given signal-to-noise ratio (SNR). However, performance can be sacrificed by other implementations of such demodulator.

The modulation method presented above will be illustrated by an example, where we choose the pulse shape

$$p ( t ) = rect ( \frac{t}{T} ) , \\ where$$

$$rect ( t ) = \{ \begin{matrix}1 & if 0 \leq t \leq 1 \\ 0 , & otherwise .\end{matrix}$$

The pulse p(t) can be any time-limited pulse, and not necessarily limited to the specific choice in this example. In addition, we set G=1 and α=1, therefore, the subcarrier frequency fₛ=½T. At the same symbol rate, this choice of subcarrier frequency gives a competitive advantage over modulation methods using use a subcarrier frequency fₛ=1/T. The advantage of this is translated to having less occupied bandwidth.

For this specific choice of p(t) and α, the normegativity constraint of the channel is satisfied by selecting the pair (ω_{i,1}, ω_{i,2}) for signal i such that

ω_{i,1}≧\sqrt{2}|ω_{i,2}|.

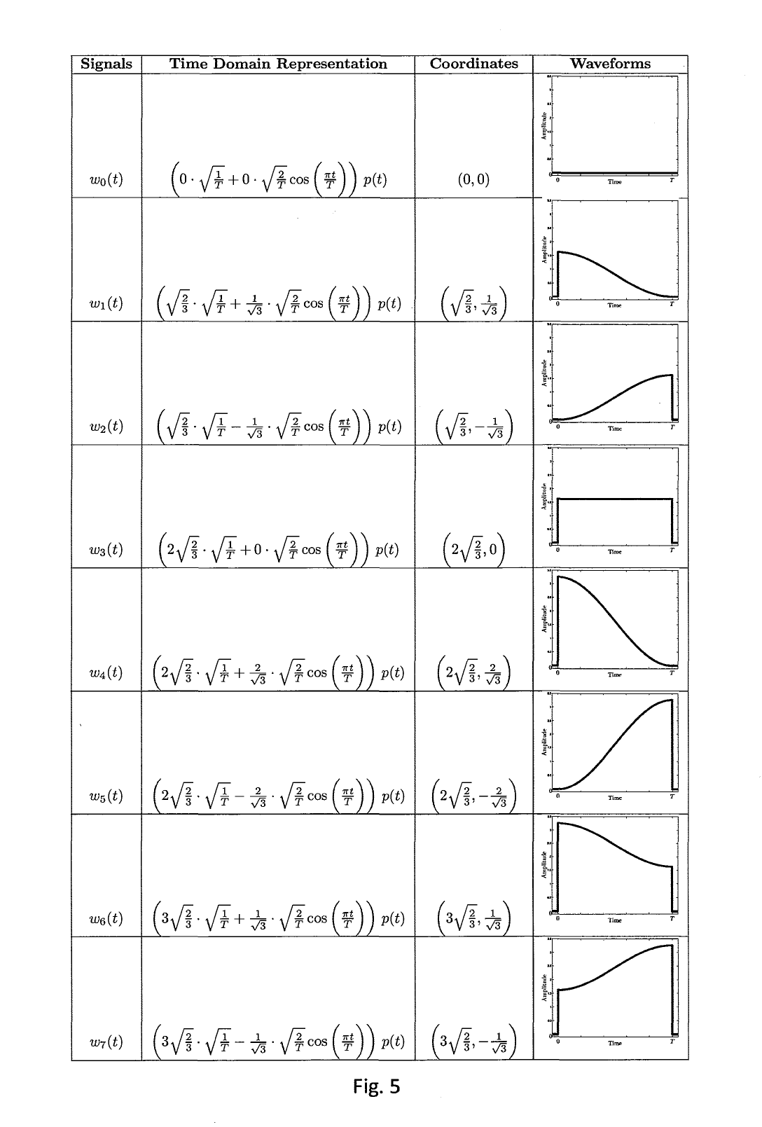

Using this requirement, we present an example of a 4- and 8-level modulation format designed using the above modulation method. The 4-level modulation format is described by the signaling set S₄={ω₀(t), ω₁, ω₂(t), ω₃(t)}, and the 8-level modulation format by S₈={ω₀(t), ω₁(t), ω₂(t), ω₃(t), ω₄(t), ω₅(t), ω₆(t), ω₇(t)}. The time domain representation together with the waveforms of the signals is presented in the table shown in FIG. 5.

The above signals can be portrayed as constellation points in signal space in terms of a set of orthonormal basis functions. For the modulation method presented, the signal space is spanned by the two orthonormal basis functions

$${ϕ}_{1} ( t ) = \sqrt{\frac{1}{T}} p ( t ) , \\ {ϕ}_{2} ( t ) = {H}^{α} ( t ) p ( t ) = \sqrt{\frac{2}{T}} cos ( \frac{π t}{T} ) p ( t ) ,$$

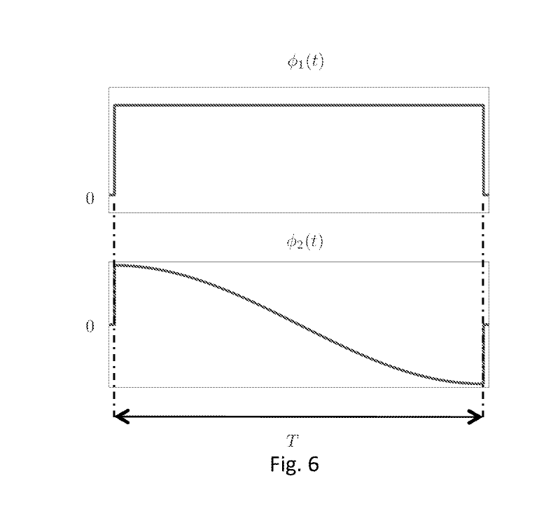

which are depicted in FIG. 6. The amplitude A is chosen such that the energy of φ₂(t) is unity. As a result, A=\sqrt{2/(2−α)} for 0<α≦1, and A={square root over (2/(1−sin c(1/α)))} for α>1, where sin c(x)=sin(πx)/(πx). Therefore, any signal belonging to the signaling set can be represented as

wᵢ(t)=G(w_{i,1φ1}(t)+w_{i,2φ2}(t)),

or in terms of the vector representation ωᵢ=(ω_{i,1}, ω_{i,2}) with respect to the aforementioned basis functions. The coordinates of each of the signals in this example are shown in the table in FIG. 5.

The normegativity constraint imposed is translated into a conical constraint in signal space. As a result, the region of space which includes all possible points (or signals) which satisfy the normegativity constraint is a two-dimensional cone with an apex angle of cos⁻¹(⅓)=70.528° pointing in the dimension spanned by φ₁(t), with vertex at the origin. It should be noted that different choices of α and p(t) lead to different apex angles.

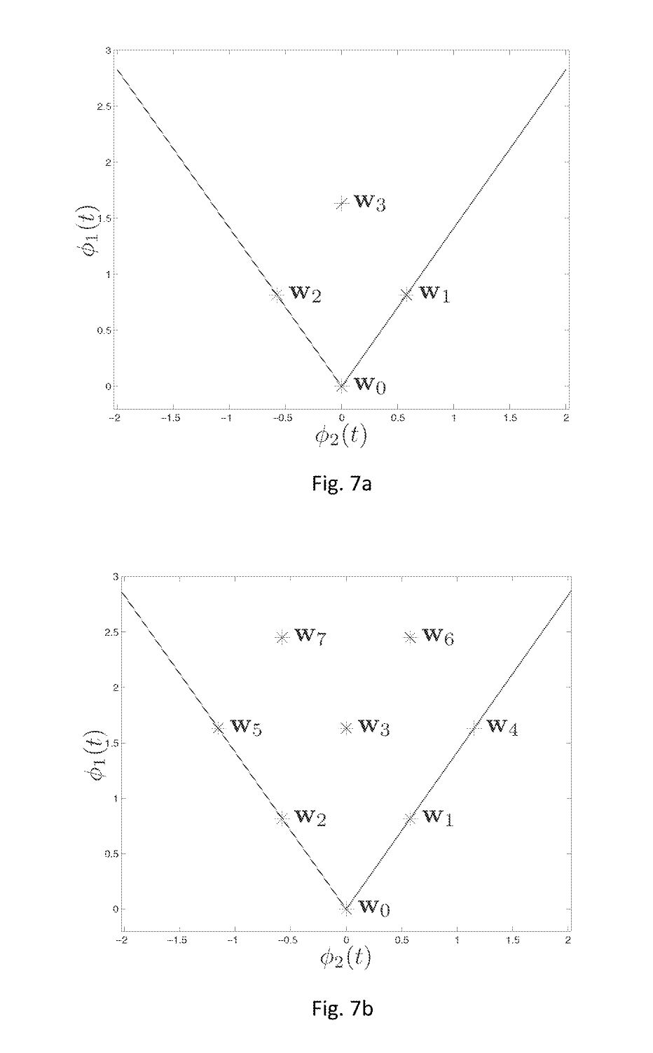

FIGS. 7a and 7b show the 4- and 8-level modulation formats in terms of their signal space, together with the conical constraint which implies that modulation formats which can be used for amplitude- or intensity-modulated communication systems belong to this conical region. These two constellations are plotted with a normalized unit minimum distance.

Using the signal space, modulation formats for amplitude- or intensity-modulated systems can be designed by sphere packing (or penny packing) inside this two-dimensional cone. Of course, other constraints can also be imposed resulting in modulation formats which are optimized for a certain power criterion (whether average or peak power), for example. It should be noted that other constellations can be designed using this conical region with a goal to satisfy other constraints, e.g., reducing the transmitter and receiver complexity.

Modulation formats designed using the above described basis functions can be used to form continuous-phase modulation or continuous-amplitude modulation. For example, consider the first four signals ωᵢ(t), i=0, 1, 2, 3, in the table in FIG. 5. In each time interval, one chooses one of the two possible signals to keep the amplitude continuous. Thus, if in time interval i one has sent ωₒ(t) or ω₁(t), then in time interval i+1 one may send either ω₀(t) or ω₂(t). If in time interval i one has sent ω₂(t) or ω₃(t), then in time interval i+1 one may send either ω₁(t) or ω₃(t). The general idea is that at every time interval fewer symbols can be selected from the signal set for transmission in order to keep the overall signal continuous. This reduces the modulation rate but can improve spectral efficiency.

In summary, a new modulation method family is proposed, which utilizes less bandwidth compared to prior art modulation methods for amplitude- or intensity-modulated communication systems. The modulation method allows the generation of a nonnegative signaling set, which is a requirement for the aforementioned type of communication systems. Signals generated using this modulation method can be portrayed in a two-dimensional Euclidean space, which in turn, leads to a simplified modulator and demodulator structure. With the presented signal space and the conical constraint that ensures the normegativity of the generated signal, other modulation formats can be generated using the modulation method. Such formats could be designed, for instance, to satisfy a cost criterion such as the average or peak power.

In conclusion, the presented modulation scheme offers better flexibility than previously known modulation formats for intensity-modulated direct-detection communication systems in that the modulation signaling set may be determined based on selected requirements of power efficiency, spectral efficiency or bit error rate.

Even though the invention has been described with reference to specific exemplifying embodiments thereof, many different alterations, modifications and the like will become apparent for those skilled in the art. Variations of the disclosed embodiments can be understood and effected by the skilled addressee in practicing the claimed invention, from a study of the drawings, the disclosure, and the appended claims. For example, even though the description above have been made in relation to a system for optical communication it is equally possible and within the scope of the invention to use the inventive concept in relation to any communication system using an intensity-modulated electromagnetic signal as an information carrier, such as wired, radio, microwave, or free-space optical transmission systems. Additionally, even though the signals are described as nonnegative, signals which are slightly negative are also included by the general inventive concept.

Furthermore, in the claims, the word “comprising” does not exclude other elements or steps, and the indefinite article “a” or “an” does not exclude a plurality.

1. Method for determining a signaling set, comprising:
selecting a first basis function in the form of a symmetric pulse represented by an even function;
selecting a second basis function orthogonal to said first basis function;
wherein said second basis function is represented by an odd function having a shape determined by a variable parameter; and
determining a signaling set comprising a plurality of data signals formed by linear combinations of said first and second basis functions based on a predetermined requirement of said signaling set.

2. The method according to claim 1, wherein said first basis function is defined for a time between 0 and T, nonnegative and even with respect to T/2; and
wherein said second basis function is defined for a time between 0 and T and odd with respect to T/2.

3. The method according to claim 1, wherein an increase of said parameter gradually varies the shape of said second basis function from a shape represented by a period of the first Walsh function to a shape represented by half a period of a cosine function to a shape represented by a period of a sawtooth function.

4. The method according to claim 1, wherein said predetermined requirement of said signaling set is a requirement with respect to spectral efficiency, power efficiency or bit error rate.

5. The method according to claim 1, wherein said linear combinations of basis functions are selected such that all of said data signals are nonnegative.

6. The method according to claim 1, wherein said second basis function is selected so that said data signals represented in signaling space are limited to a conical region in 2D Euclidian space.

7. The method according to claim 6, wherein said conical region has an apex angle greater than or equal to 60° and less than 90° depending on said second basis function.

8. The method according to claim 1, wherein said first basis function is a symmetric nonnegative pulse.

9. The method according to claim 1, wherein said first basis function is a rectangular pulse.

10. Method for modulation, the method comprising:
receiving a data stream;
determining a signaling set according to claim 1; and
forming a modulated electrical signal from the data stream by using said plurality of data signals, and providing the modulated electrical signal representing the data stream.

11. Method according to claim 10, wherein each of the plurality of data signals represents at least one data bit of the data stream.

12. Method according to claim 10, wherein the data signals are selected in a sequence such that said modulated electrical signal has a continuous amplitude.

13. Method according to claim 10, further comprising modulating a light generating device using the modulated electrical signal.

14. Method according to claim 10, further comprising modulating a laser diode using the modulated electrical signal.

15. Device for modulation, the device comprising:
a data input for receiving a data stream;
means for forming a modulated electrical signal from the data stream by using a plurality of data signals formed by linear combinations of a first and a second basis function based on a predetermined requirement of said data signals; wherein said first basis function provided in the form of a nonnegative symmetric pulse represented by an even function; said second basis function is orthogonal to said first basis function and is represented by an odd function having a shape determined by a variable parameter; and
a signal output for providing the modulated electrical signal.

16. System for transferring a data stream, the system comprising
a device for modulating a data stream, the device comprising:
a data input for receiving said data stream;
means for forming a modulated electrical signal from the data stream by using a plurality of data signals formed by linear combinations of a first and a second basis function based on a predetermined requirement of said data signals; wherein said first basis function provided in the form of a nonnegative symmetric pulse represented by an even function; said second basis function is orthogonal to said first basis function and is represented by an odd function having a shape determined by a variable parameter; and
a signal output for providing the modulated electrical signal;
a transmitter for modulating the modulated electrical signal onto an electromagnetic carrier;
a transmission line;
a receiver for receiving the modulated electromagnetic carrier and detecting its intensity or amplitude; and
a demodulator adapted for demodulating the modulated electrical signal, thereby recreating the data stream.

17. System according to claim 16, wherein the transmission line is an optical transmission line.

18. System according to claim 16, wherein the transmitter is a light generating device.

19. System according to claim 16, wherein the transmitter is a light emitting diode.

20. System according to claim 16, wherein the receiver is a photodetector.
